(19) United States
(12) Patent Application Publication
(10) Pub. No.: US 2021/0191772 A1
(43) Pub. Date: Jun. 24, 2021

(54) ADAPTABLE HIERARCHICAL SCHEDULING

(71) Applicant: CommScope Technologies LLC, Hickory, NC (US)

(72) Inventor: Arthur J. Barabell, Sudbury, MA (US)

(73) Assignee: CommScope Technologies LLC, Hickory, NC (US)

(21) Appl. No.: 17/126,664

(22) Filed: Dec. 18, 2020

Related U.S. Application Data
(60) Provisional application No. 62/950,862, filed on Dec. 19, 2019.

(51) Int. Cl. G06F 9/50; H04W 88/08

(52) U.S. Cl. CPC G06F 9/50; G06F 2209/5011; H04W 88/08

(57) ABSTRACT

One embodiment is directed to a hierarchical scheduling system that is configured to assess the configuration and operating environment of the hierarchical scheduling system and adapt the operation of the hierarchical scheduling system based thereon. The hierarchical scheduling system can be implemented, for example, as a centralized hierarchical scheduling system or as a distributed hierarchical scheduling system. The hierarchical scheduling system can be implemented in a base station (for example, to implement a Media Access Control (MAC) scheduler).

### CROSS-REFERENCE TO RELATED APPLICATIONS

This application claims the benefit of U.S. Provisional Patent Application Ser. No. 62/950,862, filed on Dec. 19, 2019, which is hereby incorporated herein by reference in its entirety.

### BACKGROUND

Schedulers are used in a wide variety of applications. One application is in a base station used to provide wireless service to user equipment using, for example, a Long-Term Evolution (LTE) wireless interface or a Fifth Generation (5G) wireless interface. In such an application, the base station includes a Media Access Control (MAC) scheduler that, among other things, assigns bandwidth resources to user equipment and is responsible for deciding on how uplink and downlink channels are to be used by the base station and user equipment.

One approach to implementing a scheduler makes use of a hierarchical scheduler (also referred to here as a “hierarchical scheduling system”). One example of a hierarchical scheduling system is an explicit hierarchical scheduling system. An explicit hierarchical scheduling system includes two types of entities (also referred to here as “nodes”)—a collection of local scheduler nodes and a centralized coordinator node. The local scheduler nodes are responsible for scheduling subsets of users and/or subsets of resources. The centralized coordinator node is responsible for supporting “cross boundary” scheduling demands and coordinating the scheduling of such demands.

Another example of a hierarchical scheduling system is an implicit hierarchical (or “distributed”) scheduling system. An implicit hierarchical scheduling system includes only one type of node. This type of node performs both the “local scheduling” and “coordination” functions that would be performed by different types of nodes in the explicit hierarchical scheduling system. A collection of these nodes is used to implement the hierarchical scheduling system in which the various nodes all “publish” their scheduling information periodically to all other nodes. As a result, all of the nodes have the same information, and can employ the same algorithms to arrive at the same “coordination” decisions in parallel. There is still a hierarchy in such an implicit hierarchical scheduling system, it is just that the “top-level” coordination decisions are occurring everywhere (that is, at all of the nodes).

For either of these two approaches, there are two different system parameters that will strongly influence the algorithm options. The first system parameter is how often local scheduling decisions need to be made. This system parameter is referred to here as “the scheduling period T_{sched}.” For instance, in an LTE system, the Transmission Time Interval (TTI) is equal to 1 millisecond. Thus, in a hierarchical LTE MAC scheduling system, the scheduling period T_{sched} equals 1 ms. In a 5G system, there are different “numerology” options, some of which entail the local scheduling algorithm to be made more frequently than in an LTE system.

The second system parameter is how much time it takes to communicate all coordination information between the various nodes. This time factor is also referred to here as the “coordination communication time Tₚᵣₒₚ.” The coordination communication time Tₚᵣₒₚ can vary considerably depending upon how the various nodes are implemented. For example, the different nodes can be implemented as different threads within the same processor, as different blades within the same chassis, and/or as different explicit, physically separate hardware units. Even within these different implementation classes, there will be further variations owing to the particular details of the technology employed and, in particular, the “link speed” for communications between the various nodes. For example, the link speeds can vary considerably (for example, 1 gigabit per second, 10 gigabits per second, 40 gigabits, etc.).

Traditionally, the basic hardware and software architecture and technology used to implement the various nodes of a hierarchical scheduling system are known. Thus, the coordination communication time Tₚᵣₒₚ, as well as the relative relationship between the coordination communication time Tₚᵣₒₚ and the scheduling period T_{sched}, are traditionally also known. As a result, design decisions about the coordination and local scheduling algorithms used in the system are made using this known value for the coordination communication time Tₚᵣₒₚ and the known relative relationship between the coordination communication time Tₚᵣₒₚ and the scheduling period T_{sched}.

However, in actual use, the coordination communication time Tₚᵣₒₚ and/or the relative relationship between the coordination communication time Tₚᵣₒₚ and the scheduling period T_{sched} for the hierarchical scheduling system may differ from the ones used in the design of the hierarchical scheduling system. As a result, the coordination and local scheduling algorithms used in the hierarchical scheduling system may not be suitable for the actual configuration, implementation, or operating environment of the hierarchical scheduling system.

For instance, the coordination and local scheduling algorithms can be designed assuming all of the nodes are to be implemented in a virtualized environment, but the virtualized environment can be actually be deployed on a hardware platform having a much higher performance than was known at the time the hierarchical scheduling system was designed. In another example, the coordination and local scheduling algorithms can be designed assuming all of the nodes are implemented on separate blades installed in a common chassis but subsequently the nodes can all be implemented together on the same processor (for example, because the number of hardware threads per core of the processor has increased due to improvements in processor technology). In yet another example, the coordination and local scheduling algorithms can be designed assuming each of the nodes are implemented on physically separate hardware units, but subsequently the coordination communication time Tₚᵣₒₚ is much greater than expected due to greater than expected congestion in the communication links between the units or due to greater than expected processing loads at the units. Thus, it may be the case that a different coordination or local scheduling algorithm may be better suited for the coordination communication time Tₚᵣₒₚ and relative relationship between the coordination communication time Tₚᵣₒₚ and the scheduling period T_{sched} that are subsequently encountered.

### SUMMARY

One embodiment is directed to a hierarchical scheduling system for scheduling resources. The hierarchical scheduling system comprises a plurality of local schedulers, each local scheduler associated with one of a plurality of user groups comprising a set of local users. The hierarchical scheduling system further comprises a set of coordination servers communicatively coupled to the plurality of local schedulers, the set of coordination servers comprising at least one coordination server. Each local scheduler is configured to receive specific needs for the resources from the local users included in the user group associated with that local scheduler, and determine general needs for resources for the associated user group based on the specific needs received from the local users included in the associated user group. The general needs for all of the user groups are communicated to the set of coordination servers. The set of coordination servers is configured to receive the general needs of all of the user groups, decide how the resources are to be assigned to the user groups, and make general grants of resources to each user group. The respective general grants for each user group are communicated to the respective local scheduler associated with that user group. Each local scheduler is configured to receive the respective general grants and make specific grants of resources individually to local users in the user group associated with that local scheduler. The hierarchical scheduling system is configured to assess the configuration and operating environment of the hierarchical scheduling system and adapt the operation of the hierarchical scheduling system based thereon.

Other embodiments are disclosed.

The details of various embodiments are set forth in the accompanying drawings and the description below. Other features and advantages will become apparent from the description, the drawings, and the claims.

### DRAWINGS

FIG. 1 illustrates one example of an explicit hierarchical scheduling system with a centralized coordination server.

FIG. 2 illustrates one example of an implicit hierarchical scheduling system with distributed coordination servers.

FIG. 3 illustrates one usage scenario performed using either the centralized hierarchical scheduling system of FIG. 1 or the distributed hierarchical scheduling system of FIG. 2.

FIG. 4 illustrates another usage scenario performed using either the centralized hierarchical scheduling system of FIG. 1 or the distributed hierarchical scheduling system of FIG. 2.

FIG. 5 comprises a high-level flowchart illustrating one exemplary embodiment of a method of adapting a hierarchical scheduling system.

FIGS. 6 and 7 illustrate examples of base stations in which an adaptive hierarchical scheduling system can be used to implement the Media Access Control (MAC) scheduler.

FIG. 8 illustrates one example of the base station of FIG. 6 implemented using a C-RAN architecture.

FIG. 9 illustrates one example of the base station of FIG. 7 implemented using a C-RAN architecture.

Like reference numbers and designations in the various drawings indicate like elements.

### DETAILED DESCRIPTION

As used here, “scheduling” refers to the periodic allocation of a limited set of resources to a population of users. In any one scheduling epoch, the resources may be “oversubscribed” (that is, there may be more users that need resources than there are resources available). In the following description, it is assumed that the scheduler runs periodically, with a scheduling period T_{sched}.

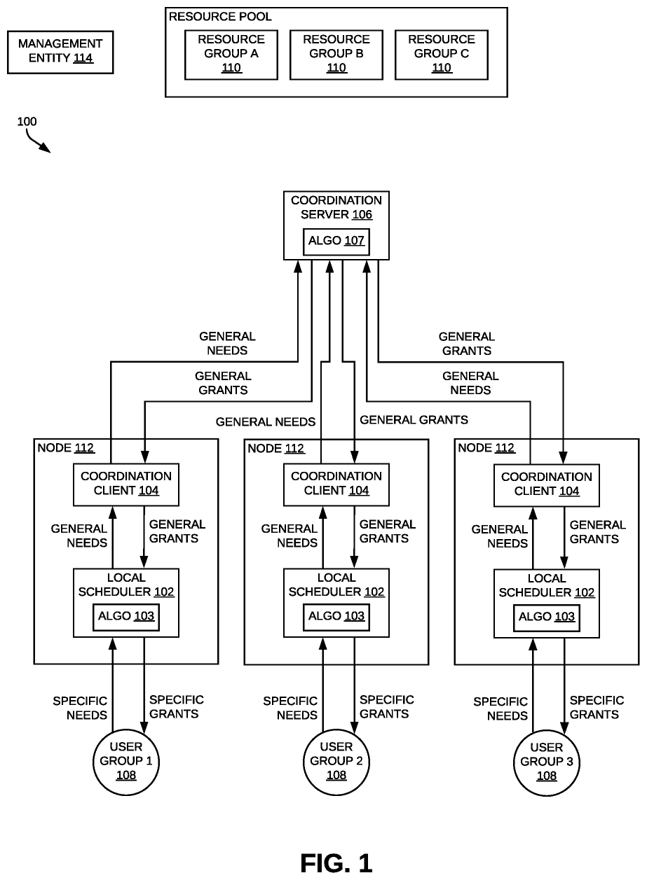

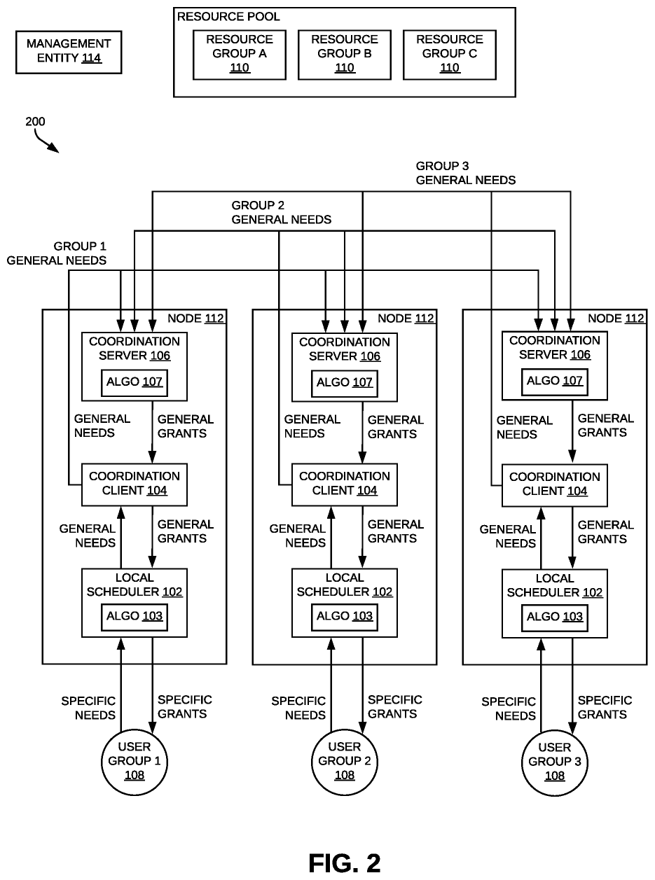

Since the problem of allocating resources among users (that is, scheduling) grows geometrically with the size of the resource pool and user pool, a “divide and conquer” approach is often used. With such an approach, the resource pool and user pool are divided into groups 108 of “local users” (where the user groups 108 are individually referenced in FIGS. 1 and 2 as “user group 1,” “user group 2,” and “user group 3) and groups 110 of local resources (where the resource groups 110 are individually referenced in FIGS. 1 and 2 as “resource group A,” “resource group B,” and “resource C”). In the examples described here, the needs of the local users from a particular user group 108 (for example, user group 1) may typically be met with the local resources from a particular resource group 110 (for example, resource group A) but that may not, and need not, be the case.

In the following description, two different types of hierarchical scheduling systems can be used—an explicit hierarchical scheduling system with a centralized coordination server and an implicit hierarchical scheduling system with distributed coordination servers. FIG. 1 illustrates one example of an explicit hierarchical scheduling system 100 with a centralized coordination server 106. FIG. 2 illustrates one example of an implicit hierarchical scheduling system 200 with distributed coordination servers 106.

Both types of hierarchical scheduling systems 100 and 200 include multiple local schedulers 102, multiple coordination clients 104 and a set of coordination servers 106, where the set of coordination servers 106 includes a single coordination server 106 in the centralized hierarchical scheduling system 100 shown in FIG. 1 and the set of coordination servers 106 includes multiple coordination servers 106 in the distributed hierarchical scheduling system 200 shown in FIG. 2. Each local scheduler 102 is associated with one of the user groups 108. Each coordination client 104 is associated with one of the user groups 108 and serves the local scheduler 104 associated with that user group 108.

Each local scheduler 102 is configured to receive “specific needs” for resources from the various local users included in the user group 108 associated with that local scheduler 102. Each local scheduler 102 is also configured to determine the “general needs” for resources of its associated user group 108 based on the specific needs it has received from its individual local users. Each local scheduler 102 then communicates the general needs to its associated coordination client 104, which communicates the general needs to the set of coordination servers 106.

As used here, “specific needs” refer to how many resources from each resource group 110 that a particular local user is requesting (for example, specific requests for 1 unit from resource group A, 2 units from resource B, and 4 units from resource group C), and “general needs” refer to how many resources from each resource group 110 all of the local users in the user group 108 associated with the local scheduler 102 are requesting (for example, general requests for 50 units from resource group A, 74 units from resource group B, and 34 units from resource group C).

Each local scheduler 102 is also configured to receive “general grants” of resources for each resource group 110 from the set of coordination servers 106 (via the coordination client 104 associated with that local scheduler 102). Each local scheduler 102 is also configured to make “specific grants” of resources for each resource group 110 individually to each local user in the user group 108 associated with that local scheduler 102. The local scheduler 102 makes the specific grants from the resources that are available to it (as indicated in the general grants made to the local scheduler 102). As used here, “general grants” refer to how many resources from each resource group 110 that the set of coordination servers 106 has determined are available to that local user scheduler 102 (for example, general grants of 55 units from resource group A, 75 units from resource group B, and 35 units from resource group C), and “specific grants” refer to the specific assignments of resources to each user in the user group 108 associated with that local scheduler 102 (for example, specific grants for a local user of 1 unit from resource group A, 2 units from resource B, and 4 units from resource group C).

Each local scheduler 102 uses a local scheduling algorithm 103 to make the specific grants of resources to each local user in the user group 108 associated with that local scheduler 102.

The time it takes the local scheduling algorithm (and the associated local scheduler 102 executing it) to make the specific grants of resources to each local user in the user group 108 associated with that local scheduler 102 is referred to here as the “local scheduling execution time T_{sched_exec}.”

Each coordination client 104 is configured to receive general needs from its associated local scheduler 102 and communicate them to the set of coordination servers 106. Also, each coordination client 104 is configured to receive general grants from the set of coordination servers 106 and communicate them to its associated local scheduler 102.

The set of coordination servers 106 is configured to receive the general needs for all of the resource groups 110, decide how the resources included in each of the resource groups are to be assigned to the various user groups and make the relevant general grants, and communicate the relevant general grants to the appropriate coordination clients 104. In the case of the centralized hierarchical scheduling system 100 shown in FIG. 1, the single coordination server 106 performs all of these operations for all of the user groups 108 and associated local schedulers 102. In the case of the distributed hierarchical scheduling system 100 shown in FIG. 1, the multiple coordination servers 106 perform these operations for the user group 108 and associated local scheduler 102 that is assigned to that coordination server 106.

Each coordination server 106 uses a coordination algorithm 107 to decide how the resources included in each of the resource groups 110 are to be assigned to the various user groups 108. The coordination algorithm 107 can be configured to reconcile the general needs across all resource groups 110 together (that is, globally across all resource groups 110) or to reconcile the general needs for each resource group 110 independently (that is, on a per-resource-group basis). The coordination algorithm 107 can be configured to operate in other ways.

Moreover, the amount of information about the demand for the resources in the various resource groups 110 used by each coordination server 106 can vary as well. In general, the more detailed the demand information each coordination server 106 uses in making the resource grant decisions, the better the decisions the coordination server 106 makes will be, at the expense of computation time.

Each coordination server 106 can use a “one-shot” coordination algorithm 107 (that is, a coordination algorithm that uses only a single iteration) or an iterative algorithm (that is, a coordination algorithm that uses multiple iterations), where the resource grant decisions each coordination server 106 makes will tend to get better as the number of iterations increases (again, at the expense of computation time).

The time it takes the coordination algorithm 107 (and the set of coordination servers 106 executing it) to perform the coordination decision making in order to make the general grants for the various user groups 108 is referred to here as the “coordination execution time T_{coord_exec}.”

As noted above, FIG. 1 illustrates one example of an explicit hierarchical scheduling system 100 with a centralized coordination server 106. That is, with the explicit hierarchical scheduling system 100 shown in FIG. 1, a single coordination server 106 is used.

The coordination clients 104 for all of the user groups 108 communicate the general needs for the associated user group 108 to the central coordination server 106, which makes the general grants for each user group 108 and communicates the respective general grants for each user group 108 to the associated coordination client 104 for forwarding on to the associated local scheduler 102. Each local scheduler 102 makes the specific grants for the local users in the associated user group 108 and communicates the specific grants to the local users.

In the example shown in FIG. 1, the local scheduler 102 and coordination client 104 for each user group 108 are implemented together in the same node 112 (though it is to be understood that the local scheduler 102 and coordination client 104 for one or more of the user groups 108 can be implemented separately from each other).

As noted above, FIG. 2 illustrates one example of an implicit hierarchical scheduling system 200 with distributed coordination servers 106. That is, with the implicit hierarchical scheduling system 200 shown in FIG. 2, the system 200 includes multiple coordination servers 106, one for each user group 108 and the associated local scheduler 102 and coordination client 104.

In the hierarchical scheduling system 200 shown in FIG. 2, the coordination client 104 for each user group 108 communicates the general needs of the associated user group 108 to all the distributed coordination servers 106. The distributed coordination server 106 for each user group 108, having received the general needs for each of the other user groups 108, makes the general grants for its associated user group 108 and communicates them to the associated coordination client 104 for forwarding on to the associated local scheduler 102. The distributed coordination servers 106 all use the same coordination algorithm 107 and same set of general needs and, therefore will be able to make the same decisions regarding general grants for all user groups 108. However, in this embodiment, only the general grants for the particular user group 108 associated with each distributed coordination server 106 are communicated to its associated coordination client 104.

In the example shown in FIG. 2, the local scheduler 102, coordination client 104, and distributed coordination server 106 for each user group 108 are implemented together in the same node 112 (though it is to be understood that one or more of the local scheduler 102, the coordination client 104, and the distributed coordination server 106 for one or more of the user groups 108 can be implemented separately from each other).

In FIGS. 1 and 2, the resource groups 110 are shown explicitly and separate from the local schedulers 102 and each coordination server 106 for ease of illustration; however, in practice, information about the resource groups 110 can be implicitly maintained by the local schedulers 102 and each coordination server 106.

In the embodiment shown in FIGS. 1 and 2, each hierarchical scheduling systems 100 and 200 includes, or are coupled to, a management entity 114 that is able to monitor and configure the operation of the respective hierarchical scheduling system 100 or 200. For example, as described in more detail below, the management entity 114 can be configured to assess the current configuration and operating environment for the respective hierarchical scheduling system 100 or 200 and adapt the operation of the respective hierarchical scheduling system 100 or 200 accordingly (for example, by changing the particular coordination and/or local scheduling algorithms 103 or 107 used, how frequently the coordination operation is performed, and if the general needs are averaged or otherwise aggregated across multiple scheduling periods).

The management entity 114 can be implemented as a part of the hierarchical scheduling system 100 or 200 (for example, as part of one or more of the entities described above) or as a part of an external management system. Also, the management entity 114 can be implemented in a centralized manner or in a distributed manner.

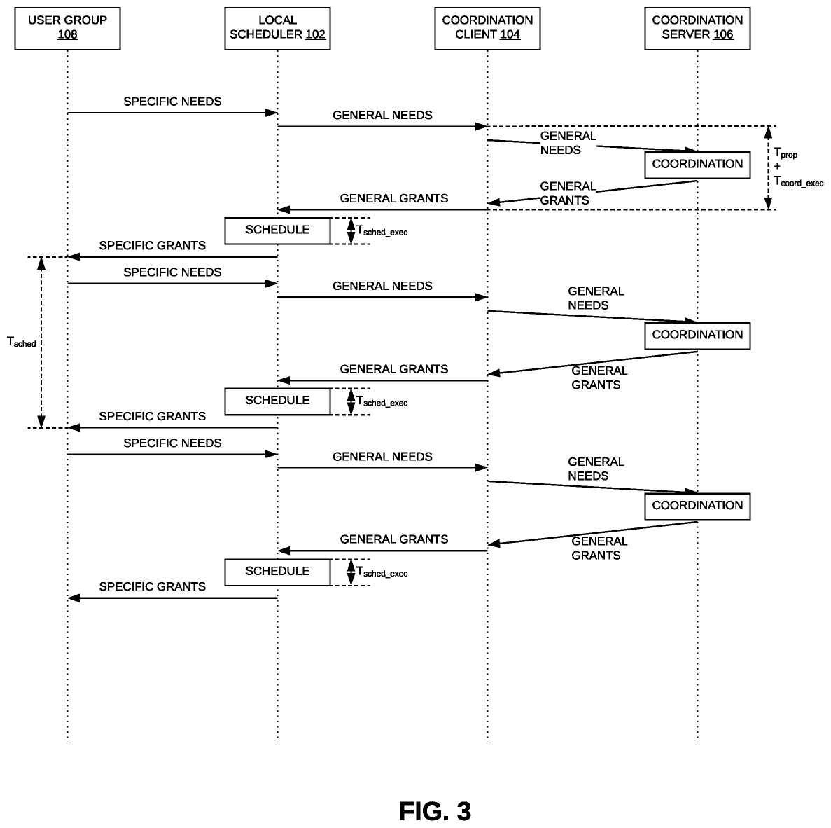

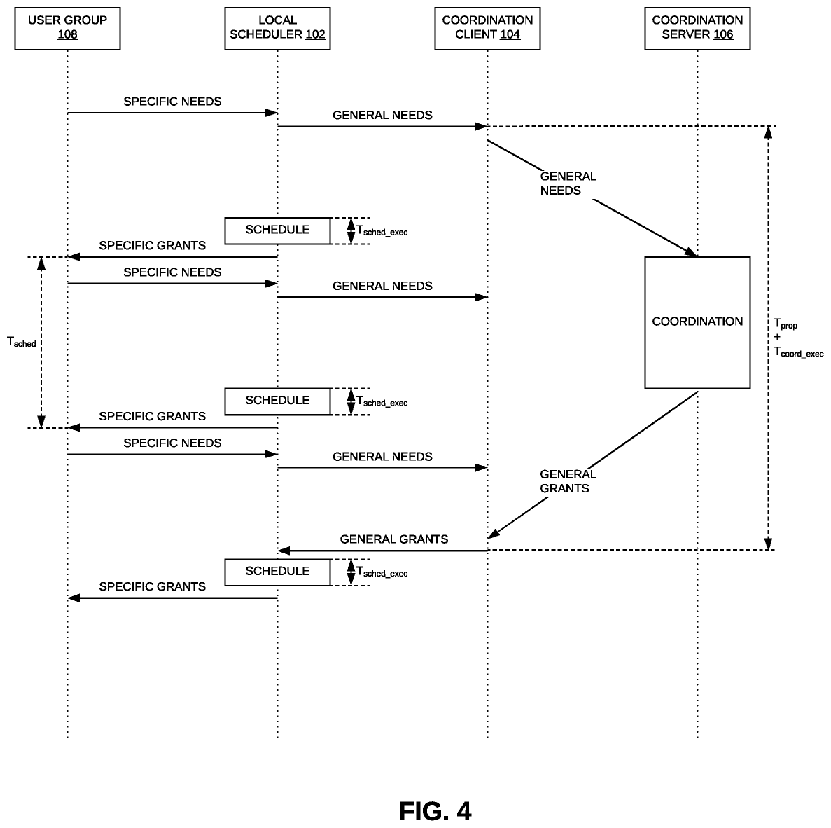

To illustrate how the different parts of the systems 100 and 200 shown in FIGS. 1 and 2 work, two exemplary usage scenarios are described below in connection with FIGS. 3 and 4.

FIG. 3 illustrates one usage scenario performed using either the centralized hierarchical scheduling system 100 of FIG. 1 or the distributed hierarchical scheduling system 200 of FIG. 2. This usage scenario is also referred to here as “fast coordination.”

FIG. 4 illustrates another usage scenario performed using either the centralized hierarchical scheduling system 100 of FIG. 1 or the distributed hierarchical scheduling system 200 of FIG. 2. This usage scenario is also referred to here as “slow coordination.”

As shown in FIGS. 3 and 4, the coordination communication time Tₚᵣₒₚ comprises two parts. The first part is the sum of the time it takes for the general needs for the various user groups 108 to be communicated from the respective local schedulers 102 to the associated coordination clients 104 and the time it takes for the general needs for the various user groups 108 to be communicated from the various coordination clients 104 to the centralized coordination server 106. The second part of the coordination communication time Tₚᵣₒₚ is the sum of the time it takes for the general grants to be communicated from the coordination server 106 to the various coordination clients 104 and the time it takes for the general grants to be communicated from the various coordination clients 104 to the various local schedulers 102.

As shown in FIGS. 3 and 4, the time it takes the coordination server 106 (and the coordination algorithm 107 used thereby) to perform the coordination decision making in order to make the general grants for the various user groups 108 comprises the coordination execution time T_{coord_exec}.

As shown in FIGS. 3 and 4, the time it takes local schedulers 102 (and the local scheduling algorithm 103 used thereby) to perform the local scheduling for the various user groups 108 in order to make the specific grants for the various local users comprises the local scheduling execution time T_{sched_exec}.

In general, each of the different types of entities of the scheduling systems 100 and 200 will carry out the various operations described above in parallel, and the times noted above for each operation represent the time it takes all of the various entities performing that operation in parallel to complete that operation (that is, the respective time will ultimately be determined by the entity that is last to complete that operation).

In the fast coordination usage scenario shown in FIG. 3, the communication of coordination information and the coordination decision making (that is, “coordination operation”) occurs fast enough that the total (sum) of the coordination communication time Tₚᵣₒₚ, the coordination execution time T_{coord_exec}, and the local scheduling execution time T_{sched_exec} is less than the overall scheduling period T_{sched}. As a result, it makes sense to perform the coordination operation with the same periodicity that the local scheduler 102 schedules the local users (that is, the coordination operation can be performed once for each scheduling period T_{sched}).

In the slow coordination usage scenario shown in FIG. 4, the coordination communications and coordination decision making do not occur fast enough so that the total (sum) of the coordination communication time Tₚᵣₒₚ, the coordination execution time T_{coord_exec}, and the local scheduling execution time T_{sched_exec} is greater than the overall scheduling period T_{sched}. As a result, it does not make sense to perform the coordination operation with the same periodicity that the local scheduler 102 schedules the local users. Moreover, the general needs reported by the coordination clients 104 to the set of coordination servers 106 should be an average (or other aggregation) of the general needs of the associated user groups 108 over many scheduling periods since the general grants made by the set of coordination servers 106 will be in effect for several scheduling periods. In FIG. 4, the averaging of the general needs to produce the averaged general needs reported by the coordination clients 104 to the set of coordination servers 106 is not explicitly shown. In the example shown in FIG. 4, the local schedulers 102 report the general needs of their associated user groups 108 as frequently as the users report them (that is, once for each scheduling period), whereas the coordination clients 104 averages (or otherwise aggregates) the general needs reported by the local schedulers 102 and reports the averaged general needs to the set of coordination servers 106 at a rate consistent with how frequently the coordination operation is performed. It is to be understood, however, that this “averaging” of needs can be performed in other ways (for example, each coordination server 106 can perform the averaging or other aggregation).

As noted above, traditionally, hierarchical scheduling systems are designed assuming a predetermined, fixed value for the coordination communication time Tₚᵣₒₚ and a predetermined, fixed known relative relationship between the coordination communication time Tₚᵣₒₚ and the scheduling period T_{sched}. However, in actual use, the coordination communication time Tₚᵣₒₚ and relative relationship between the coordination communication time Tₚᵣₒₚ and the scheduling period T_{sched} for the hierarchical scheduling system may differ from those used in the design of the hierarchical scheduling system. As a result, the particular coordination and/or local scheduling algorithms that are used, how frequently the coordination operation is performed, and/or if and how the general needs are averaged or otherwise aggregated across multiple scheduling periods may not be suitable in actual use of the hierarchical scheduling system.

To address this issue, each hierarchical scheduling system 100 and 200 can be configured to assess the current configuration and operating environment for the respective hierarchical scheduling system 100 or 200 and adapt the operation of the respective hierarchical scheduling system 100 or 200 accordingly (for example, by changing the particular coordination and/or local scheduling algorithms 103 or 107 used, how frequently the coordination operation is performed, and if and how the general needs are averaged or otherwise aggregated across multiple scheduling periods).

In order to perform such adaptation of the respective hierarchical scheduling system 100 or 200, actual values for the various system parameters T_{sched}, T_{sched_exec}, Tₚᵣₒₚ, and T_{coord_exec} are determined for the actual environment in which the system 100 or 200 is used. These values can be manually entered, determined or calculated based on characteristics of the particular configuration or implementation of the system 100 or 200 (for example, using a look-up table), and/or by measuring actual times for these values (and possibly averaging or otherwise smoothing or filtering these measured values).

Once values for these system parameters T_{sched}, T_{sched_exec}, Tₚᵣₒₚ, and T_{coord_exec} are determined, the systems 100 and 200 can be adapted accordingly.

One way to consider these system parameters T_{sched}, T_{sched_exec}, Tₚᵣₒₚ, and T_{coord_exec} employs the following ratio:

(T_{sched}−T_{sched_exec})/(Tₚᵣₒₚ+T_{coord_exec})

This is the ratio of the local scheduling “slack time” for a given scheduling period (that is, T_{sched}−T_{sched_exec}) to the total time needed to perform one full coordination operation (that is, Tₚᵣₒₚ+T_{coord_exec}).

If this ratio is greater than 1, then the current configuration and operating environment is such that a full coordination operation can be performed for each scheduling period T_{sched}. Indeed, if this ratio is much greater than 1, then more extensive coordination can be performed (for example, using more detailed demand information or performing multiple iterations of an iterative coordination algorithm 107).

Another way to consider these system parameters T_{sched}, T_{sched_exec}, Tₚᵣₒₚ, and T_{coord_exec} determines a “time budget” for the coordination operation, which is determined as:

T_{sched}−T_{sched_exec}−Tₚᵣₒₚ

If this time budget is less than 0 (that is, is negative) or very small (that is, is less than the coordination execution time T_{coord_exec}), there is not sufficient time for a full coordination operation to be performed for each scheduling period T_{sched}. If this time budget is large (that is, is close to the largest possible value, T_{sched}), then more extensive coordination can be performed. For example, the time budget can be used to determine the number of iterations of an iterative coordination algorithm 107 that will be performed for each coordination operation. One way to do this is to repeatedly perform iterations of the iterative coordination algorithm 107 until the remaining time budget is not sufficient to perform another iteration.

If this time budget is less than 0 (that is, negative) or very small (that is, is less than the coordination execution time T_{coord_exec}) and there is not sufficient time for a full coordination operation to be performed for each scheduling period T_{sched}, then the following considerations apply.

In the following description, N represents how frequently the coordination operations are performed. N is expressed in scheduling periods. That is, one full coordination operation is performed for every N scheduling periods. For example, if N=1, one full coordination operation is performed for each scheduling period. If N=3, one full coordination operation is performed for every three 3 scheduling periods.

In general, the smallest suitable N is selected. N can be determined by finding the smallest N that satisfies the following condition:

N*T_{sched}−T_{sched_exec}−Tₚᵣₒₚ>T_{coord_exec}

Also, when assessing the general demands for each user group 108, the general demands for each user group 108 can be averaged or otherwise aggregated across a number of scheduling periods equal to N (assuming N is greater than one) so that the set of coordination servers 106 can allocate the resources accordingly.

Moreover, when N is greater than 1 and the general demands are being averaged, the set of coordination servers 106 can allocate the resources from each resource group 110 independently of the other resource groups 110 as doing so is likely to be more efficient than allocating the resources from all resource groups 110 together. The loss in optimality in allocating the resources from each resource group 110 independently may not be important since the allocation decisions are already being made based on averaged general needs.

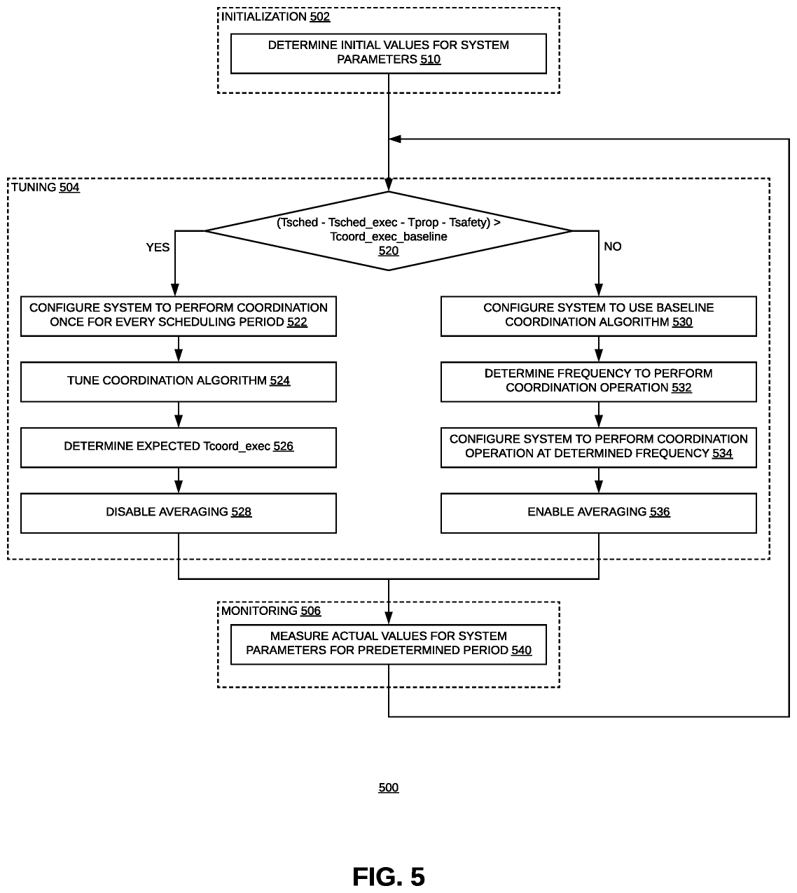

One example of how the hierarchical scheduling systems 100 and 200 can be configured to assess the current configuration and operating environment for the hierarchical scheduling systems 100 and 200 and adapt the operation of the hierarchical scheduling systems 100 and 200 accordingly is shown in FIG. 5.

FIG. 5 comprises a high-level flowchart illustrating one exemplary embodiment of a method 500 of adapting a hierarchical scheduling system. The embodiment of method 500 shown in FIG. 5 is described here as being implemented in either the centralized hierarchical scheduling system 100 described above in connection with FIG. 1 or the distributed hierarchical scheduling system 200 described above in connection with FIG. 2. More specifically, the processing associated with method 500 is described as being performed by the management entity 114 for the hierarchical scheduling system 100 or 200. It is to be understood, however, that other embodiments can be implemented in other ways.

The blocks of the flow diagram shown in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel and/or in an event-driven manner). Also, most standard exception handling is not described for ease of explanation; however, it is to be understood that method 500 can and typically would include such exception handling. Moreover, one or more aspects of method 500 can be configurable or adaptive (either manually or in an automated manner). For example, various measurements or statistics can be captured and used to fine tune the method 500.

Method 500 comprises three phases—an initialization phase 502, a tuning phase 504, and a monitoring phase 506.

In this exemplary embodiment, the set of coordination servers 106 is configured to use two different coordination algorithms 107—a “baseline” coordination algorithm that is a one-shot algorithm and an “enhanced” coordination algorithm that is an iterative algorithm. For the iterative algorithm, a time budget for the coordination operation to be performed is determined, and the time budget is in turn used to determine the number of iterations of the iterative coordination algorithm 107 that will be performed for each coordination operation.

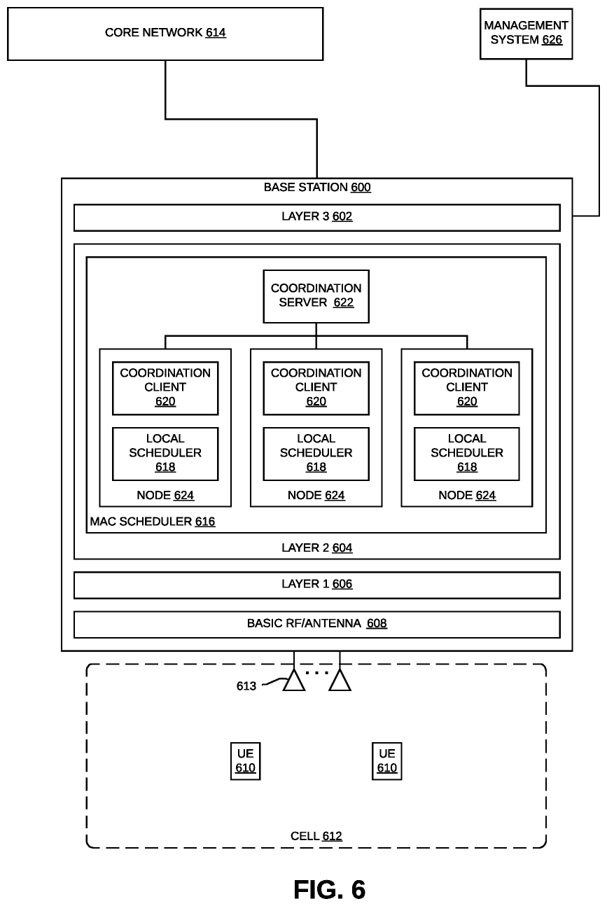

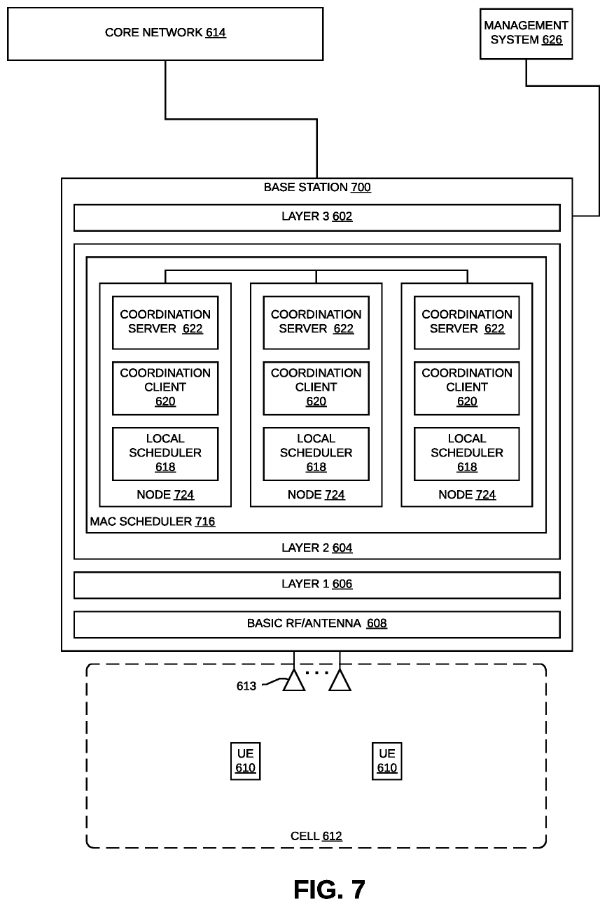

The initialization phase 502 of method 500 comprises determining initial values for the various system parameters (block 510). In this embodiment, this involves determining an initial value for the scheduling period T_{sched} by determining the current configuration of the system 100 (for example, identifying what wireless interface is used when implemented as described below in connection with FIGS. 6 and 7) and then using a look-up table to identify a value for the scheduling period T_{sched} using the current system configuration.

In this embodiment, a configurable safety margin T_{safety} is used for the processing described below, the initial value of which can be determined by reading it from a lookup table.

An initial value for the local scheduling execution time T_{sched_exec} can be determined by first determining the particular local scheduling algorithm 103 that is being used in the local schedulers 102 and determining the clock speed of the processor executing that algorithm (for example, by querying the local schedulers 102 for both items of information) and then reading from a look-up table an appropriate local scheduling execution time T_{sched_exec} for that local scheduling algorithm 103 and clock speed.

An initial value for the coordination communication time Tₚᵣₒₚ can be determined by measuring it (for example, using test or loop back messages).

An initial value for the time it will take for the baseline coordination algorithm to be performed is determined. This value is also referred to here as the “baseline coordination execution time T_{coord_exec_basline}.”

The baseline coordination execution time T_{coord_exec_baseline} can be determined by first determining the particular baseline coordination algorithm 107 that is being used in the set of coordination servers 106 and determining the clock speed of the processor executing that algorithm (for example, by querying the set of coordination servers 106 for both items of information) and then reading from a look-up table an appropriate baseline coordination execution time T_{coord_exec_basline} for that baseline coordination algorithm 107 and clock speed.

After the initial values for the various system parameters are determined, method 500 proceeds to the tuning phase 504.

The tuning phase 504 comprises determining if the time budget for performing the coordination operation is greater than the baseline coordination execution time T_{coord_exec_baseline} (block 520). In this embodiment, the time budget for performing the coordination operation is determined as follows:

T_{sched}−T_{sched_exec}−Tₚᵣₒₚ−T_{safety}

If the time budget for performing the coordination operation is greater than the baseline coordination execution time T_{coord_exec_baseline}, the system 100 is configured to perform a full coordination operation once for every scheduling period (that is, N is set to 1) (block 522).

As noted above, N represents how frequently a full coordination operation is to be performed, expressed in scheduling periods. Thus, in this case N is set to 1 scheduling period.

Also, the coordination algorithm 107 is tuned as a function of the timing budget for performing the coordination operation (block 524). The coordination algorithm 107 is tuned by first determining if the timing budget is large enough to permit the iterative coordination algorithm 107 to be used instead of the baseline coordination algorithm 107. If that is not the case, the baseline coordination algorithm 107 is used and no further tuning is performed.

If the timing budget is large enough to permit the iterative coordination algorithm 107 to be used, the iterative coordination algorithm 107 is used and is further tuned by using the current timing budget to determine how many iterations of the iterative coordination algorithm 107 are to be performed for each coordination operation.

An expected value for the coordination execution time T_{coord_exec} for the tuned coordination algorithm is determined (block 526). For example, if the iterative coordination algorithm 107 is used instead of the baseline coordination algorithm 107, an expected value for the coordination execution time T_{coord_exec} corresponding to the tuned coordination algorithm will differ from the baseline coordination execution time T_{coord_exec_baseline}.

Since, in this case, a full coordination operation is performed once for every scheduling period (that is, N=1), averaging of the general needs for the various user groups 108 is not needed and is disabled (block 528).

Then, the hierarchical scheduling system 100, as adapted as a result of performing the processing associated with blocks 522-528, allocates resources from the various resource groups 110 to the local users for the various user groups 108 (which includes performing the coordination operations).

At this point, method 500 proceeds to the monitoring phase 506.

Referring again to block 520, if the time budget for performing a coordination operation is not greater than the baseline coordination execution time T_{coord_exec_baseline}, system 100 is configured to use the baseline coordination algorithm for coordination (block 530) and the frequency to perform the coordination operations is determined as a function of the time budget (block 532). The system 100 is then configured to perform the coordination operations at the determined frequency (block 534). In this embodiment, the frequency to perform the coordination operations is determined by dividing the time budget by the baseline coordination execution time T_{coord_exec_baseline} and applying a ceiling function to the result (the ceiling function returning the smallest integer that is equal to or greater than the result of the division operation)

Since a full coordination operation is performed less frequently than once every scheduling period (that is, N>1), the system 100 is configured to average the general needs for the various user groups 108 (block 536).

Then, the hierarchical scheduling system 100, as adapted as a result of performing the processing associated with blocks 530-534, allocates resources from the various resource groups 110 to the local users for the various user groups 108 (which includes performing the coordination operations).

At this point, method 500 proceeds to the monitoring phase 506.

The monitoring phase 506 of method 500 comprises measuring actual values for the various system parameters for a predetermined period (block 540). During this predetermined period, the hierarchical scheduling system 100, as adapted as a result of performing the tuning processing described above, allocates resources from the various resource groups 110 to the local users for the various user groups 108 (which includes performing the coordination operations).

In this embodiment, for each full coordination operation that is performed, the time it takes for the local scheduler 102 to perform the local scheduling is measured (that is, an actual value for the local scheduling execution time T_{sched_exec} is measured), the time it takes the various coordination communications to occur is measured (that is, an actual value for the coordination communication time Tₚᵣₒₚ is measured), and the time it takes for the coordination algorithm to be performed is measured (that is, an actual value for the coordination execution time T_{coord_exec} is measured). These measurements can be averaged or otherwise smoothed or filtered in order to determine a single updated current value for each of these system parameters. In the case of the updated coordination execution time T_{coord_exec}, if the baseline coordination algorithm is not being used, then the updated current value for coordination execution time T_{coord_exec} is used to determine a correction factor for the baseline coordination execution time T_{coord_exec_baseline} (for example, by determining a percentage change in the updated current value for the coordination execution time T_{coord_exec}) and then applying that correction factor to the baseline coordination execution time T_{coord_exec_baseline} in order to determine an updated value for the baseline coordination execution time T_{coord_exec_baseline}.

As noted above, the hierarchical scheduling system 100 (and the various nodes thereof) can be implemented in various ways (where each such way of implementing the hierarchical scheduling system 100 can use different types of technology and equipment having different performance characteristics). One way to monitor and measure actual propagation times of various communications within the hierarchical scheduling system 100 is to time stamp messages used for such communications when they are sent and received (assuming the various nodes of the hierarchical scheduling system 100 have their clocks locked to a common source). Another way to monitor and measure actual propagation times of various communications within the hierarchical scheduling system 100 is to use special-purpose loopback messages that are used to calculate the roundtrip time it takes such messages to traverse the various communication paths in the hierarchical scheduling system 100.

After this measuring has been done for the predetermined period of time, the monitoring phase 506 is completed and the tuning phase 504 is repeated using the updated system values (returning to block 520).

In this way, the hierarchical scheduling system 100 assesses its current configuration and operating environment and automatically adapts the operation of the hierarchical scheduling system 100 accordingly.

By automatically adapting the hierarchical scheduling system 100 based on the current configuration and operating environment, more extensive coordination can be used when the current configuration and operating environment support doing so, while ensuring that less extensive coordination can be used when the current configuration and operating environment necessitates it. In this way, the benefits using more extensive coordination (for example, more optimal resource allocation) can be achieved where possible. Also, by doing such adaptation automatically, these benefits can be achieved without requiring complex manual analysis of the current configuration or operating environment or manual configuration of the hierarchical scheduling system 100 while avoiding the issues that would result if the hierarchical scheduling system 100 was misconfigured to use a coordination scheme that is not suited to the current configuration or operating environment.

For instance, a hierarchical scheduling system 100 that was designed assuming all of the nodes are to be implemented in a virtualized environment deployed on a given hardware platform may later be implemented in a virtualized environment deployed on a much more powerful hardware platform. In another example, a hierarchical scheduling system 100 that was designed assuming all of the nodes are implemented on separate blades installed in a common chassis may later be implemented in way that has all the nodes implemented together as separate threads running on the same processor (for example, because the number of hardware threads per core of the processor has increased due to improvements in processor technology). In these examples, the time budget for performing the coordination operation should increase and, as a result, the hierarchical scheduling system 100 can be adapted to perform more extensive coordination.

In another example, a hierarchical scheduling system 100 that was designed assuming each of the nodes of the system 100 are implemented on physically separate hardware units with a particular expected coordination communication time Tₚᵣₒₚ may in actual practice experience total coordination communicates times Tₚᵣₒₚ that are much greater than expected due to greater than expected congestion in the communication links between the units or due to greater than expected processing loads at the units. In these examples, the time budget for performing coordination should decrease and, as a result, the hierarchical scheduling system 100 can be adapted to perform less extensive coordination (for example, by performing the baseline coordination algorithm 107 less frequently and averaging the general needs for resources across multiple scheduling periods).

The adaptive hierarchical scheduling systems 100 and 200 shown in FIGS. 1 and 2 can be used to implement the Media Access Control (MAC) scheduler in a base station. Two examples of such base stations 600 and 700 are shown in FIGS. 6 and 7, respectively.

In the example shown in FIG. 6, the base station 600 implements the Layer-3 functions 602, Layer-2 functions 604, Layer-1 function 606, and basic RF functions 608 for the wireless interface used to serve user equipment (UE) 610 for each cell 612 implemented by the base station 600. The base station 600 is coupled to or includes one or more antennas 613 used for wirelessly communicating with the UEs 610. Also, the base station 600 is communicatively coupled to a core network 614 of a wireless operator's network.

The base station 600 can be implemented in various ways. For example, the base station 600 can be implemented using a traditional macro base station configuration, a microcell, picocell, femtocell or other “small cell” configuration, or a centralized or cloud RAN (C-RAN) configuration. The base station 600 can be implemented in other ways.

In this example, the Layer-2 functions 604 of the base station 600 include a MAC scheduler 616. The MAC scheduler 616 is configured to, among other things, assign bandwidth resources to UEs 610 and is responsible for deciding on how uplink and downlink channels are to be used by the base station 600 and the UEs 610.

In the example shown in FIG. 6, the MAC scheduler 616 is implemented as a centralized hierarchical scheduling system as described above in connection with FIG. 1. That is, the MAC scheduler 616, in this example, includes multiple scheduling entities, which comprise multiple local schedulers 618, multiple coordination clients 620, and a set of coordination servers 622 (which, in this embodiment, includes a single centralized coordination server 622). These various entities operate as described above in order to implement the MAC scheduler 616 for the wireless interface used by the base station 600 used to communicate with the UEs 610. Also, in this example, each local scheduler 618 is implemented together with its associated coordination client 620 in a respective common node 624.

The various UEs 610 can be assigned to different user groups 619 (for example, based on the location of the UEs 610 or using a hash function). Also, the resources to be scheduled by the MAC scheduler 616 comprise resource blocks for the various channels supported by the wireless interface, where these resources can be grouped into resource groups by channel.

In the example shown in FIG. 6, a management system 626 can be coupled to the base station 600, for example, via the Internet and/or local area network (LAN) in order to monitor and configure and control the base station 600.

Except as explicitly indicated below, the base station 700 shown in FIG. 7 is implemented in the same way as the base station 600 shown in FIG. 6.

In the example shown in FIG. 7, the MAC scheduler 716 of the base station 700 is implemented as a distributed hierarchical scheduling system as described above in connection with FIG. 2. That is, the MAC scheduler 716, in this example, includes multiple scheduling entities, which comprise multiple local schedulers 618, multiple coordination clients 620, and multiple distributed coordination servers 622. These various entities operate as described above in connection with FIG. 2 in order to implement the MAC scheduler 716 for the wireless interface used by the base station 700 that is used to communicate with the UEs 610. Also, in this example, each local scheduler 618 is implemented together with its associated coordination client 620 and coordination server 622 in a respective common node 724.

In the examples shown in FIGS. 6 and 7, the base stations 600 and 700 are configured so that they can use different wireless interfaces to communicate with the UEs 610 (for example, an LTE wireless interface or a 5G wireless interface).

Also, in the examples shown in FIGS. 6 and 7, the base stations 600 and 700 (and, more specifically, the respective MAC schedulers 616 and 716) can be implemented in various ways. For example, the different nodes 624 and set of coordination servers 622 (which includes a single centralized coordination server 622 in the case of the base station 600 shown in FIG. 6 and which includes multiple distributed coordination servers 622 in the case of the base station 700 shown in FIG. 7) can be implemented as different threads within the same processor, as different blades within the same chassis, and/or as different explicit, physically separate hardware units. Even within these different implementation classes, there can be further variations owing to the particular details of the technology employed and, in particular, the link speed for communications between the various nodes.

In the examples shown in FIGS. 6 and 7, the scheduling period T_{sched} for the MAC schedulers 616 and 716 is a function of the particular wireless interface that is being used. For example, if an LTE wireless interface is being used, the scheduling period T_{sched} will be 1 millisecond (ms). If a 5G wireless interface is being used, the scheduling period T_{sched} depends on the particular numerology that is being used and it may be less than 1 ms. The scheduling period T_{sched} for the MAC schedulers 616 and 716 can therefore be determined in a straightforward manner from the particular wireless interface that is used (and the particular numerology used if a 5G wireless interface is used).

In the examples shown in FIGS. 6 and 7, the local scheduling execution time T_{sched_exec} for the MAC schedulers 616 and 716 is a function of many factors including, for example, a clock speed of a processor used to execute the scheduling algorithm, the amount of users, user groups, resources, and resource groups the schedulers 616 and 716 are scheduling and the local scheduling algorithm used by the local schedulers 618. The local scheduling execution time T_{sched_exec} for the MAC schedulers 616 and 716 can be determined, for example, from a look-up table that includes various local scheduling execution times T_{sched_exec} associated with various combinations of such factors (for example, the look-up table can include entries for various ranges of users and resources for each different scheduling algorithm that may be used). The local scheduling execution time T_{sched_exec} for the MAC schedulers 616 and 716 can also be determined by monitoring and measuring the actual performance of the local schedulers 618 and averaging many measured local scheduling execution times over many scheduling periods.

In the examples shown in FIGS. 6 and 7, the coordination communication time Tₚᵣₒₚ for the MAC schedulers 616 and 716 can be determined by monitoring and measuring actual propagation times and averaging many such measured actual propagation times.

In the examples shown in FIGS. 6 and 7, the coordination execution time T_{coord_exec} for the MAC schedulers 616 and 716 is a function of many factors including, for example, a clock speed of a processor used to execute the coordination algorithm, the number of users, user groups, resources, and resource groups the schedulers 616 and 716 are scheduling and the particular coordination algorithm used. The coordination execution time T_{coord_exec} for the MAC schedulers 616 and 716 can be determined, for example, from a look-up table that includes various coordination execution times T_{coord_exec} associated with various combinations of such factors (for example, the look-up table can include entries for various ranges of users and resources for each different coordination algorithm that may be used). The coordination execution time T_{coord_exec} for the MAC schedulers 616 and 716 can also be determined by monitoring and measuring the actual performance of the coordination servers 622 and averaging many measured coordination execution times.

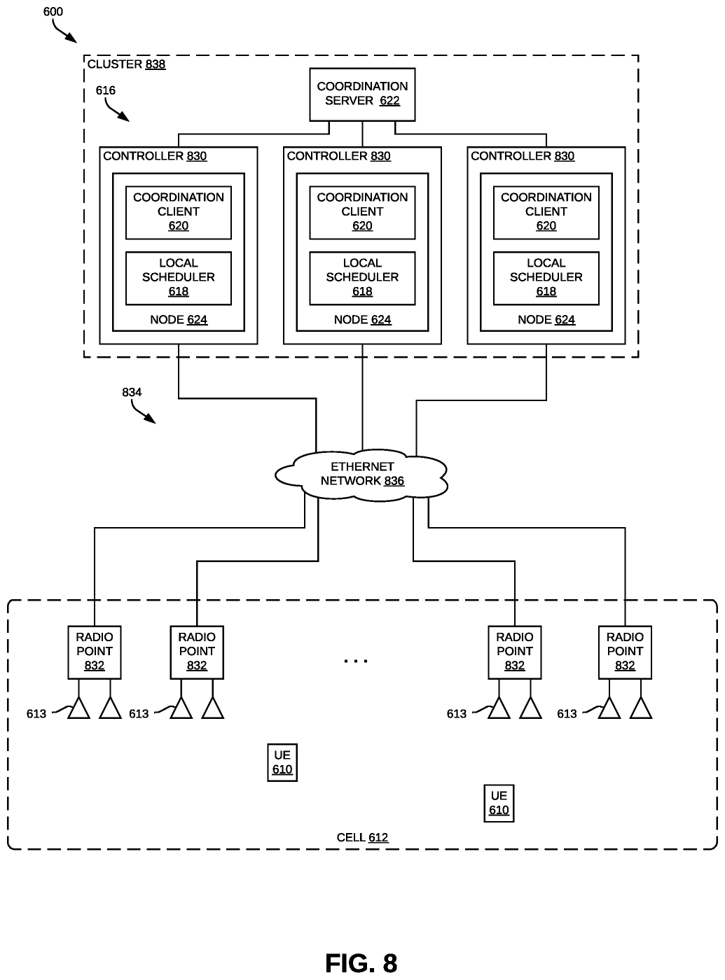

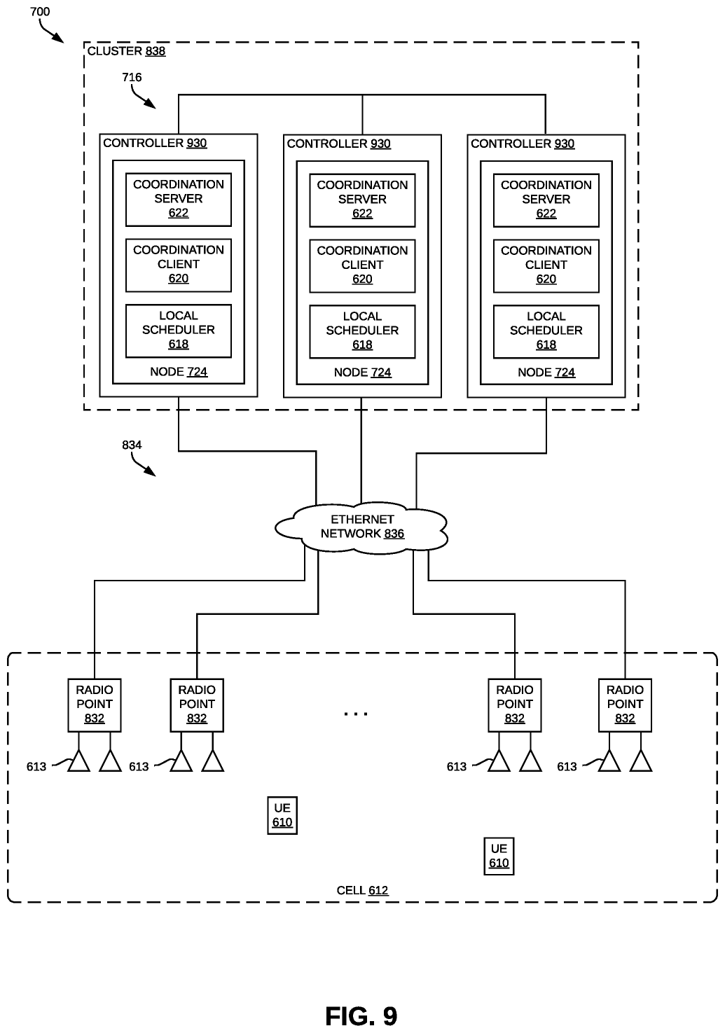

As noted above, the base stations 600 and 700 can be implemented using a C-RAN architecture. FIG. 8 illustrates one example of the base station 600 of FIG. 6 implemented using a C-RAN architecture. Likewise, FIG. 9 illustrates one example of the base station 700 of FIG. 7 implemented using a C-RAN architecture.

In the example shown in FIG. 8, the C-RAN architecture used to implement the base station 600 employs multiple baseband units 830 and multiple radio points (RPs) 832. Each RP 832 is remotely located from the baseband units 830. Also, in this example, at least one of the RPs 832 is remotely located from at least one other RP 832. The baseband units 830 and RPs 832 serve at least one cell 612. The baseband units 830 are also referred to here as “baseband controllers” 830 or just “controllers” 830. The controllers 830 are implemented in a cluster 838 and are able to communicate with each other.

Each RP 832 includes or is coupled to one or more antennas 613 via which downlink RF signals are radiated to various items of user equipment (UE) 610 and via which uplink RF signals transmitted by UEs 610 are received.

The controllers 830 are communicatively coupled to the radio points 832 using a front-haul network 834. In the exemplary embodiment shown in FIG. 8, the front-haul 834 that communicatively couples the controllers 830 to the RPs 832 is implemented using a standard switched Ethernet network 836. However, it is to be understood that the front-haul between the controllers 830 and RPs 832 can be implemented in other ways (for example, the front-haul between the controllers 830 and RPs 832 can be implemented using private networks and/or public networks such as the Internet).

Each controller 830 is assigned a subset of the RPs 832. Also, each controller 830 is assigned a group of UEs 610, where that controller 830 performs the wireless-interface Layer-3 and Layer-2 processing (including scheduling) for that group of UEs 610 as well as at least some of the wireless-interface Layer-1 (physical layer) processing and where the radio points 832 perform the wireless-interface Layer-1 processing not performed by the controller 830 as well as implementing the analog RF transceiver functions.

Different splits in the wireless-interface processing between the controllers 830 and the radio points 832 can be used for each of the physical channels of the wireless interface. That is, the split in the wireless-interface processing between the controllers 830 and the radio points 832 used for one or more downlink physical channels of the wireless interface can differ from the split used for one or more uplink physical channels of the wireless interface. Also, for a given direction (downlink or uplink), the same split in the wireless-interface processing does not need to be used for all physical channels of the wireless interface associated with that direction.

Appropriate fronthaul data is communicated between the controllers 830 and the radio points 832 over the front-haul 834 in order to support each split that is used.

In the example shown in FIG. 8, the MAC scheduler 616 is implemented as a centralized hierarchical scheduling system as described above in connection with FIG. 6. In this example, each local scheduler 618 is implemented together with its associated coordination client 620 in a respective common node 624 that is deployed on a respective one of the controllers 830. The single centralized coordination server 622 is also deployed in the cluster 838 along with the controllers 830. The controllers 830 and centralized coordination server 622 are able to communicate with each other. These various entities operate as described above in order to implement the MAC scheduler 616 for the wireless interface that is used by the base station 600 to communicate with the UEs 610.

Except as explicitly indicated below, the C-RAN base station 700 shown in FIG. 9 is implemented in the same way as the C-RAN base station 600 shown in FIG. 8. The description of the C-RAN base station 600 set forth above with respect to FIG. 8 applies to the C-RAN base station 700 shown in FIG. 9, except as explicitly indicated below.

In the example shown in FIG. 9, the MAC scheduler 716 is implemented as a distributed hierarchical scheduling system as described above in connection with FIG. 7. In this example, each local scheduler 618 is implemented together with its associated coordination client 620 and coordination server 622 in a respective common node 724 that is deployed on a respective one of the controllers 930. These various entities operate as described above in order to implement the MAC scheduler 716 for the wireless interface that is used by the base station 700 to communicate with the UEs 610.

For each UE 610 that is served by the cell 612, the controller 830 or 930 for that UE 610 assigns a subset of that cell's RPs 832 to that UE 610 for downlink wireless transmissions that are made to that UE 610. This subset of RPs 832 is referred to here as the “simulcast zone” for that UE 610. The simulcast zone for each UE 610 can include any of the RPs 832 that serve the cell 612—including both RPs 832 assigned to the controller 830 or 930 for that UE 610 as well as RPs 832 assigned to other controllers 830 or 930.

The simulcast zone for each UE 610 is determined, in this example, based on receive power measurements made at each of the RPs 832 for certain uplink transmissions from the UE 610 (for example, LTE Physical Random Access Channel (PRACH) and Sounding Reference Signals (SRS) transmissions) and is updated as the UE 610 moves throughout the cell 612. The RP 832 having the “best” receive power measurement for a UE 610 is also referred to here as the “primary RP” 832 for the UE 610.

The receive power measurements made at each of the RPs 832 for a given UE 610 (and the primary RP 832 determined therefrom) can be used to estimate the location of the UE 610. In general, it is expected that a UE 610 will be located in the coverage area of its primary RP 832, which is the reason why that RP 832 has the best receive power measurement for that UE 610.

As noted above, in the examples shown in FIGS. 8 and 9, each UE 610 is assigned to one of the controllers 830 or 930 (and its associated local scheduler 618) for scheduling. In this example, the assignment is made based on the current location of the UE 610. As noted above, the current location of each UE 610 is determined based on the primary RP 832 for the UE 610. That is, each UE 610 is considered to be located near its primary RP 832 and is assigned to the controller 830 or 930 (and its associated local scheduler 618) to which that primary RP 832 is assigned. Stated another way, the “user group” assigned to each local scheduler 618 comprises the UEs 610 that currently have a primary RP 832 that is in the set of RPs 832 associated with that local scheduler 618 (and the controller 830 or 930 on which that local scheduler 618 is implemented).

One example of resource coordination that can be performed in the examples shown in FIGS. 8 and 9 relates to gaining access to the RPs 832 in order to transmit to a UE 610 using the antennas 613 of those RPs 832. That is, in addition to coordinating and scheduling access to frequency resources, the MAC scheduler 616 or 716 (which is implemented using the adaptive hierarchical scheduling techniques described above) also coordinates and schedules resources related to gaining access to the RPs 832 and the hardware included in or associated the RPs 832 (such as the antennas 613, processing hardware, and front-haul capacity).

As noted above, downstream transmissions are transmitted (simulcasted) to a UE 610 from the one or more RPs 832 that are currently in the simulcast group for that UE 610. As a result of how the UEs 610 are assigned to the local schedulers 618, the primary RP 832 for each UE 610 will be associated with the local scheduler 618 (and controller 830 or 930) that performs scheduling for that UE 610. However, the other non-primary RPs 832 in the simulcast group for each UE 610 may be associated with a different local scheduler 618. As a result, the local schedulers 618 need to coordinate with each other in order to gain access to the border RPs 832.

The UEs 610 associated with a given local scheduler 618 can be classified into two subsets—“inner” UEs 610 and “border” UEs 610. An inner UE 610 is a UE 610 that includes in its simulcast group only RPs 832 that are associated with that UE's local scheduler 618. A border UE 610 is a UE 610 that includes in its simulcast group one or more RPs 832 that are associated with a different local scheduler 618. Any RP 832 that is included in the simulcast groups of only UEs 610 that are scheduled by their local scheduler 618 is referred to here as an “inner” RP 832. Any RP 832 that is included in the simulcast group of at least one UE 610 that is scheduled by a local scheduler 618 other than the one associated with that RP 832 is referred to here as a “border” RP 832.

Each local scheduler 618 will typically need to coordinate with other local schedulers 618 for access to border RPs 832—both border RPs 832 associated with the controller 830 or 930 on which it is implemented and border RPs 832 that are associated with other controllers 830 or 930.

For each scheduling period, each local scheduler 618 is configured to receive, from each UE 610 to be scheduled by that local scheduler 618, which border RPs 832 that UE 610 needs access to for the scheduling period (that is, each UE's 610 “specific needs” for access to the border RPs 832 during the scheduling period). For each scheduling period, each local scheduler 618 is also configured to determine the “general needs” for access to the border RPs 832 of its associated group of UEs 610 based on the specific needs it has received from those individual UEs 610. Each local scheduler 618 then communicates the general needs for its UE group for the scheduling period to its associated coordination client 620, which communicates the general needs to the set of coordination servers 622 (that is, to the centralized coordination server 622 in the example shown in FIG. 8 or to its respective distributed coordination server 622 in the example shown in FIG. 9).

The set of coordination servers 622 is configured to receive the general needs of all of the UE groups for access to the border RPs 832 for the relevant scheduling period, decide how access to the border RPs 832 is to be assigned to the various UE groups for the scheduling period and make the relevant general grants to those UE groups, and communicate the general grants to the coordination clients 620. In the example shown in FIG. 8, the single centralized coordination server 622 performs all of these operations for all of the UE groups and associated local schedulers 618. In the example shown in FIG. 9, each of the multiple distributed coordination servers 622 perform these operations for the associated UE group and local scheduler 618 that is assigned to that coordination server 622.

In particular, in the system of FIG. 9, each coordination client 620 transmits the general needs of its associated user group to all the coordination servers 622. Each coordination server 622 thus has the same information and can make the same decisions.

For each scheduling period, each local scheduler 618 is also configured to receive the general grant of access to the border RPs 832 from the relevant coordination server 622 (via the coordination client 620 associated with that local scheduler 618). For each scheduling period, each local scheduler 618 is also configured to make specific grants of access to the various border RPs 832 individually to each UE 610 in the UE group associated with that local scheduler 618. The local scheduler 618 makes the specific grants of access to the border RPs 832 from the general access made available to it (as indicated in the general grants made to the local scheduler 618).

Access to border RPs is only one example of a resource for which coordination and scheduling can be implemented in a C-RAN base station system using the adaptive hierarchical scheduling techniques described here. It is to be understood, however, that the adaptive hierarchical scheduling techniques described here can also be used in such C-RAN base station systems to coordinate and schedule other resources.

The C-RAN base station 600 shown in FIG. 8 and the C-RAN base station 700 shown in FIG. 9 can be implemented in accordance with one or more public standards and specifications. For example, the C-RAN base station 600 and the C-RAN base station 700 can be implemented in accordance with one or more public specifications defined by the O-RAN Alliance in order to provide 4G LTE and/or 5G NR wireless service. (“0-RAN” stands for “Open Radio Access Network.”) In such an O-RAN example, the controllers 830 and 930 and the radio points 832 can be implemented as O-RAN distributed units (O-DUs) and O-RAN remote units (O-RUs), respectively, in accordance with the O-RAN specifications. Also, in such an O-RAN example, the coordination server 622 can be implemented, at least in part, as a part of an O-RAN near real-time RAN intelligent controller (O-RAN Near RT RIC). The C-RAN base station 600 and the C-RAN base station 700 (including, without limitation, the controllers 830 and 930, radio points 832, and/or the coordination servers 622) can be implemented in other ways.

Each hierarchical scheduling system and base station described above (and the various functions and features described as being included therein or used therewith) can also be referred to as “circuitry” or a “circuit” that implements that item (including, for example, circuitry or a circuit included in special-purpose or general-purpose hardware or a virtual platform that executes software). One example of a virtual platform or virtualized environment that can be used employs the Kubernetes system. For example, the coordination server 106 and the nodes 112 shown in FIG. 1 and the nodes 112 shown in FIG. 2 can each be implemented using a different Kubernetes pod, potentially instantiated on different processors or other hardware (that is, on different Kubernetes nodes). In other examples, the coordination server 622 and the nodes 624 shown in FIG. 6 and the nodes 724 shown in FIG. 7 can each be implemented using a different Kubernetes pod, potentially instantiated on different processors or other hardware. Other implementations are possible.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### Example Embodiments

Example 1 includes a hierarchical scheduling system for scheduling resources, the hierarchical scheduling system comprising: a plurality of local schedulers, each local scheduler associated with one of a plurality of user groups comprising a set of local users; and a set of coordination servers communicatively coupled to the plurality of local schedulers, the set of coordination servers comprising at least one coordination server; wherein each local scheduler is configured to receive specific needs for the resources from the local users included in the user group associated with that local scheduler, and determine general needs for resources for the associated user group based on the specific needs received from the local users included in the associated user group; wherein the general needs for all of the user groups are communicated to the set of coordination servers; wherein the set of coordination servers is configured to receive the general needs of all of the user groups, decide how the resources are to be assigned to the user groups, and make general grants of resources to each user group; wherein the respective general grants for each user group are communicated to the respective local scheduler associated with that user group; wherein each local scheduler is configured to receive the respective general grants and make specific grants of resources individually to local users in the user group associated with that local scheduler; wherein the hierarchical scheduling system is configured to assess the configuration and operating environment of the hierarchical scheduling system and adapt the operation of the hierarchical scheduling system based thereon.

Example 2 includes the hierarchical scheduling system of Example 1, further comprising a plurality of coordination clients, each coordination client associated with one of the local schedulers; and wherein the respective general needs for each user group are communicated from the local scheduler associated with that user group to the set of coordination servers via the coordination client associated with that user group; and wherein the respective general grants for each user group are communicated from the set of coordination servers to the local scheduler associated with that user group via the coordination client associated with that user group.

Example 3 includes the hierarchical scheduling system of Example 2, wherein for each user group, the associated local scheduler and coordination client are implemented together in a single node.

Example 4 includes the hierarchical scheduling system of any of Examples 1-3, wherein the set of coordination servers comprises a plurality of coordination servers, wherein each user group has an associated coordination server and the general needs of all of the user groups are communicated to all of the coordination servers; wherein each coordination server is configured to receive the general needs of all of the user groups, decide how the resources are to be assigned to the user group associated with that coordination server, and make general grants of resources to the user group associated with that coordination server; and wherein the coordination servers are configured to use a common coordination algorithm.

Example 5 includes the hierarchical scheduling system of Example 4, wherein for each user group, the associated local scheduler and the associated coordination server are implemented together in a single node.

Example 6 includes the hierarchical scheduling system of Example 5, further comprising a plurality of coordination clients, each coordination client associated with one of the local schedulers; and wherein for each user group, the associated local scheduler, the associated coordination client, and the associated coordination server are implemented together in a single node.

Example 7 includes the hierarchical scheduling system of any of Examples 1-6, wherein the set of coordination servers comprises one coordination server.

Example 8 includes the hierarchical scheduling system of Example 7, further comprising a plurality of coordination clients, each coordination client associated with one of the local schedulers; and wherein the respective general needs for each user group are communicated from the local scheduler associated with that user group to the one coordination server via the coordination client associated with that user group; and wherein the respective general grants for each user group are communicated from the one coordination server to the local scheduler associated with that user group via the coordination client associated with that user group.

Example 9 includes the hierarchical scheduling system of Example 8, wherein for each user group, the associated local scheduler and coordination client are implemented together in a single node.

Example 10 includes the hierarchical scheduling system of any of Examples 7-9, wherein the general needs of all of the user groups are communicated to the one coordination server; wherein the one coordination server is configured to receive the general needs of all of the user groups, decide how the resources are to be assigned to the user groups, and make general grants of resources to the user groups.

Example 11 includes the hierarchical scheduling system of any of Examples 1-10, wherein the hierarchical scheduling system is configured to assess the configuration and operating environment of the hierarchical scheduling system by doing one or more of the following: determining a local scheduling execution time for a local scheduling algorithm used in the local schedulers; determining a coordination execution time for a coordination algorithm used in the set of coordination servers; determining a coordination communication time for communication of the general needs and the general requests; and determining a scheduling period for the hierarchical scheduling system.

Example 12 includes the hierarchical scheduling system of Example 11, wherein one or more of the local scheduling execution time, the coordination execution time, the coordination communication time, and the scheduling period are determined by doing one or more of the following: using a look-up table to look up a value; and measuring a value.

Example 13 includes the hierarchical scheduling system of any of Examples 1-12, wherein the hierarchical scheduling system is configured to adapt the operation of the hierarchical scheduling system based on one or more of the following: a local scheduling execution time for a local scheduling algorithm used in the local schedulers; a coordination execution time for a coordination algorithm used in the set of coordination servers; a coordination communication time for communication of the general needs and the general requests; and a scheduling period for the hierarchical scheduling system.

Example 14 includes the hierarchical scheduling system of any of Examples 1-13, wherein the hierarchical scheduling system is configured to adapt the operation of the hierarchical scheduling system by changing how frequently each full coordination operation is performed, wherein each full coordination operation comprises: the communication of the general needs of all of the user groups to the set of coordination servers, the deciding by the set of coordination servers how the resources are to be assigned to the user groups, the making by the set of coordination servers of general grants of resources to each user group, and the communication of the respective general grants for each user group to the respective local scheduler associated with that user group.

Example 15 includes the hierarchical scheduling system of Example 14, wherein the hierarchical scheduling system is configured to average the general needs across multiple scheduling periods if the full coordination operation is performed less frequently than once per scheduling period.

Example 16 includes the hierarchical scheduling system of Example 14-15, wherein the hierarchical scheduling system is configured to further adapt the operation of the hierarchical scheduling system by tuning a coordination algorithm used by the set of coordination servers if the full coordination operation is performed once per scheduling period.

Example 17 includes the hierarchical scheduling system of Example 16, wherein the hierarchical scheduling system is configured to tune the coordination algorithm used by the set of coordination servers by tuning an iterative coordination algorithm as a function of a time budget for the full coordination operation to be performed.

Example 18 includes the hierarchical scheduling system of any of Examples 1-17, wherein the hierarchical scheduling system is implemented in a base station.

Example 19 includes the hierarchical scheduling system of Example 18, wherein the base station is implemented as a centralized radio access network (C-RAN) base station comprising multiple controllers and multiple radio points, and wherein each local scheduler is implemented on a respective one of the controllers.

Example 20 includes the hierarchical scheduling system of any of Examples 18-19, wherein the resources comprise access to resources associated with the radio points.

Example 21 includes the hierarchical scheduling system of any of Examples 18-20, wherein the hierarchical scheduling system is used to implement a Media Access Control (MAC) scheduler for a wireless interface served by the base station.

Example 22. includes the hierarchical scheduling system of any of Examples 18-21, wherein a scheduling period for how frequently the local schedulers schedule the local users of the associated user groups is determined based on a wireless interface implemented by the base station.

Example 23 includes the hierarchical scheduling system of any of Examples 1-22, wherein the hierarchical scheduling system is implemented using at least one of: one or more threads executed by a common processor; a virtualized environment; different blades inserted into a common chassis; and physically separate hardware units.

Example 24 includes the hierarchical scheduling system of any of Examples 1-23, wherein the hierarchical scheduling system is designed assuming the hierarchical scheduling system will be implemented using hardware that has a first performance level, wherein the hierarchical scheduling system is actually implemented using hardware that has a second performance level that differs from the first performance level.

Example 25 includes the hierarchical scheduling system of any of Examples 1-24, wherein the hierarchical scheduling system is designed assuming the hierarchical scheduling system will be implemented using communication links that provide a first link speed, wherein the communication links actually used to implement the hierarchical scheduling system provide a second link speed that differs from the first link speed.

What is claimed is:

1. A hierarchical scheduling system for scheduling resources, the hierarchical scheduling system comprising:
a plurality of local schedulers, each local scheduler associated with one of a plurality of user groups comprising a set of local users; and
a set of coordination servers communicatively coupled to the plurality of local schedulers, the set of coordination servers comprising at least one coordination server;
wherein each local scheduler is configured to receive specific needs for the resources from the local users included in the user group associated with that local scheduler, and determine general needs for resources for the associated user group based on the specific needs received from the local users included in the associated user group;
wherein the general needs for all of the user groups are communicated to the set of coordination servers;
wherein the set of coordination servers is configured to receive the general needs of all of the user groups, decide how the resources are to be assigned to the user groups, and make general grants of resources to each user group;
wherein the respective general grants for each user group are communicated to the respective local scheduler associated with that user group;
wherein each local scheduler is configured to receive the respective general grants and make specific grants of resources individually to local users in the user group associated with that local scheduler;
wherein the hierarchical scheduling system is configured to assess the configuration and operating environment of the hierarchical scheduling system and adapt the operation of the hierarchical scheduling system based thereon.

2. The hierarchical scheduling system of claim 1, further comprising a plurality of coordination clients, each coordination client associated with one of the local schedulers; and
wherein the respective general needs for each user group are communicated from the local scheduler associated with that user group to the set of coordination servers via the coordination client associated with that user group; and
wherein the respective general grants for each user group are communicated from the set of coordination servers to the local scheduler associated with that user group via the coordination client associated with that user group.

3. The hierarchical scheduling system of claim 2, wherein for each user group, the associated local scheduler and coordination client are implemented together in a single node.

4. The hierarchical scheduling system of claim 1, wherein the set of coordination servers comprises a plurality of coordination servers, wherein each user group has an associated coordination server and the general needs of all of the user groups are communicated to all of the coordination servers;
wherein each coordination server is configured to receive the general needs of all of the user groups, decide how the resources are to be assigned to the user group associated with that coordination server, and make general grants of resources to the user group associated with that coordination server; and
wherein the coordination servers are configured to use a common coordination algorithm.

5. The hierarchical scheduling system of claim 4, wherein for each user group, the associated local scheduler and the associated coordination server are implemented together in a single node.

6. The hierarchical scheduling system of claim 5, further comprising a plurality of coordination clients, each coordination client associated with one of the local schedulers; and
wherein for each user group, the associated local scheduler, the associated coordination client, and the associated coordination server are implemented together in a single node.

7. The hierarchical scheduling system of claim 1, wherein the set of coordination servers comprises one coordination server.

8. The hierarchical scheduling system of claim 7, further comprising a plurality of coordination clients, each coordination client associated with one of the local schedulers; and
wherein the respective general needs for each user group are communicated from the local scheduler associated with that user group to the one coordination server via the coordination client associated with that user group; and
wherein the respective general grants for each user group are communicated from the one coordination server to the local scheduler associated with that user group via the coordination client associated with that user group.

9. The hierarchical scheduling system of claim 8, wherein for each user group, the associated local scheduler and coordination client are implemented together in a single node.

10. The hierarchical scheduling system of claim 7, wherein the general needs of all of the user groups are communicated to the one coordination server;
wherein the one coordination server is configured to receive the general needs of all of the user groups, decide how the resources are to be assigned to the user groups, and make general grants of resources to the user groups.

11. The hierarchical scheduling system of claim 1, wherein the hierarchical scheduling system is configured to assess the configuration and operating environment of the hierarchical scheduling system by doing one or more of the following:
determining a local scheduling execution time for a local scheduling algorithm used in the local schedulers;
determining a coordination execution time for a coordination algorithm used in the set of coordination servers;
determining a coordination communication time for communication of the general needs and the general requests; and
determining a scheduling period for the hierarchical scheduling system.

12. The hierarchical scheduling system of claim 11, wherein one or more of the local scheduling execution time, the coordination execution time, the coordination communication time, and the scheduling period are determined by doing one or more of the following:
using a look-up table to look up a value; and
measuring a value.

13. The hierarchical scheduling system of claim 1, wherein the hierarchical scheduling system is configured to adapt the operation of the hierarchical scheduling system based on one or more of the following:
a local scheduling execution time for a local scheduling algorithm used in the local schedulers;
a coordination execution time for a coordination algorithm used in the set of coordination servers;
a coordination communication time for communication of the general needs and the general requests; and
a scheduling period for the hierarchical scheduling system.

14. The hierarchical scheduling system of claim 1, wherein the hierarchical scheduling system is configured to adapt the operation of the hierarchical scheduling system by changing how frequently each full coordination operation is performed, wherein each full coordination operation comprises: the communication of the general needs of all of the user groups to the set of coordination servers, the deciding by the set of coordination servers how the resources are to be assigned to the user groups, the making by the set of coordination servers of general grants of resources to each user group, and the communication of the respective general grants for each user group to the respective local scheduler associated with that user group.

15. The hierarchical scheduling system of claim 14, wherein the hierarchical scheduling system is configured to average the general needs across multiple scheduling periods if the full coordination operation is performed less frequently than once per scheduling period.

16. The hierarchical scheduling system of claim 14, wherein the hierarchical scheduling system is configured to further adapt the operation of the hierarchical scheduling system by tuning a coordination algorithm used by the set of coordination servers if the full coordination operation is performed once per scheduling period.

17. The hierarchical scheduling system of claim 16, wherein the hierarchical scheduling system is configured to tune the coordination algorithm used by the set of coordination servers by tuning an iterative coordination algorithm as a function of a time budget for the full coordination operation to be performed.

18. The hierarchical scheduling system of claim 1, wherein the hierarchical scheduling system is implemented in a base station.

19. The hierarchical scheduling system of claim 18, wherein the base station is implemented as a centralized radio access network (C-RAN) base station comprising multiple controllers and multiple radio points, and wherein each local scheduler is implemented on a respective one of the controllers.

20. The hierarchical scheduling system of claim 18, wherein the resources comprise access to resources associated with the radio points.

21. The hierarchical scheduling system of claim 18, wherein the hierarchical scheduling system is used to implement a Media Access Control (MAC) scheduler for a wireless interface served by the base station.

22. The hierarchical scheduling system of claim 18, wherein a scheduling period for how frequently the local schedulers schedule the local users of the associated user groups is determined based on a wireless interface implemented by the base station.

23. The hierarchical scheduling system of claim 1, wherein the hierarchical scheduling system is implemented using at least one of:
one or more threads executed by a common processor;
a virtualized environment;
different blades inserted into a common chassis; and
physically separate hardware units.

24. The hierarchical scheduling system of claim 1, wherein the hierarchical scheduling system is designed assuming the hierarchical scheduling system will be implemented using hardware that has a first performance level, wherein the hierarchical scheduling system is actually implemented using hardware that has a second performance level that differs from the first performance level.

25. The hierarchical scheduling system of claim 1, wherein the hierarchical scheduling system is designed assuming the hierarchical scheduling system will be implemented using communication links that provide a first link speed, wherein the communication links actually used to implement the hierarchical scheduling system provide a second link speed that differs from the first link speed.
